(19) United States
(12) Patent Application Publication
(10) Pub. No.: US 2012/0257052 A1
(43) Pub. Date: Oct. 11, 2012

(54) ELECTRONIC DEVICE AND METHOD FOR DETECTING ABNORMITIES OF IMAGE CAPTURING DEVICE

(75) Inventors: CHIH-CHENG YANG, Tu-Cheng (TW); TE-HSING CHUNG, Tu-Cheng (TW)

(73) Assignee: HON HAI PRECISION INDUSTRY CO., LTD., Tu-Cheng (TW)

(21) Appl. No.: 13/433,292

(22) Filed: Mar. 29, 2012

(30) Foreign Application Priority Data
Apr. 8, 2011 (TW) 100112156

(51) Int. Cl. H04N 7/18; G08B 21/00

(52) U.S. Cl. 348/143; 348/E07.085

(57) ABSTRACT

In a method for detecting an abnormity of an image capturing device, an image of a monitored area is captured, and an image texture of the image is calculated according to the image. When a count of image textures recorded in a history record list is greater than a predetermined value, the method compares the image texture with at least two image textures recorded in the history record list, to determine whether the image is abnormal. If the image is abnormal, the method increments an abnormity record value of the image capturing device by a value of one. Once the abnormity record value is equal to an alert value, the method generates an alarm to warn of an abnormity of the image capturing device.

### 1. TECHNICAL FIELD

Embodiments of the present disclosure generally relate to image capturing device management, and more particularly to an electronic device and a method for detecting an abnormity of an image capturing device using the electronic device.

### 2. DESCRIPTION OF RELATED ART

Image capturing devices (i.e., cameras) are installed everywhere, such as public sites for monitoring people and/or vehicles around the public sites. The public site may be a corridor of an office building, a roadside, an airport, a bus station, or a railway station, for example. When the image capturing devices are interfered with or destroyed, in such manners as being turned away or blocked, images cannot be captured clearly. Although a person can detect whether one of the image capturing devices has been interfered with according to the captured images, the method of manual detection is time consuming.

### BRIEF DESCRIPTION OF THE DRAWINGS

FIG. 1 is a block diagram of one embodiment of an electronic device including an abnormity detection system.

FIG. 2 is a block diagram of one embodiment of function modules of the abnormity detection system of FIG. 1.

FIG. 3 is a schematic diagram illustrating calculation of an image texture of an image captured by an image capturing device.

FIG. 4 is a flowchart illustrating one embodiment of a method for detecting an abnormity of an image capturing device using the abnormity detection system of FIG. 1.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device.

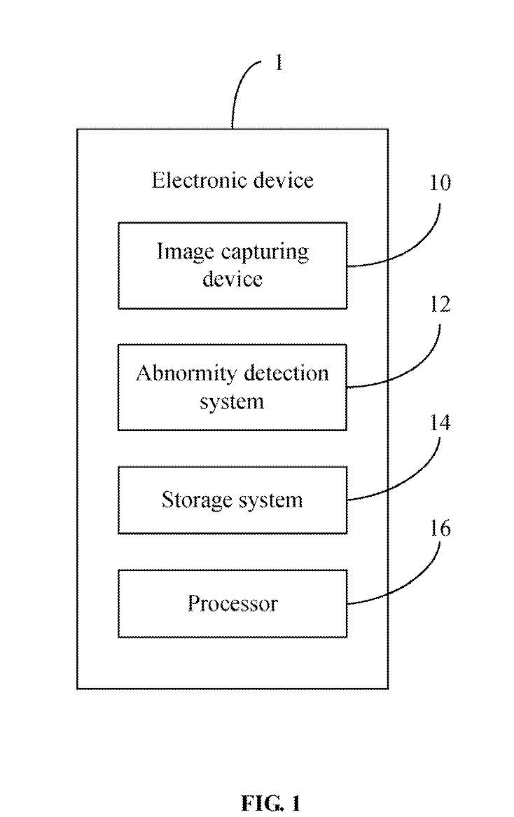

FIG. 1 is a schematic diagram of one embodiment of an electronic device 1 including an abnormity detection system 12. In the embodiment, the electronic device 1 may further include an image capturing device 10, a storage system 14, and at least one processor 16. The abnormity detection system 12 may detect an abnormal situation of the electronic device 1 that affects the image capturing device 10 by analyzing images captured by the image capturing device 10. One or more computerized codes of the abnormity detection system 12 are stored in the storage system 14 and executed by the at least one processor 16.

In one embodiment, the storage system 20 may be a magnetic or an optical storage system, such as a hard disk drive, an optical drive, or a tape drive. The storage system 20 also stores the images captured by the image capturing device 10, and a history record list for recording image textures of the images. It should be understood that an image texture is a set of metrics calculated in image processing designed to quantify a perceived texture of an image. Image texture provides information about the spatial arrangement of color or intensities in an image or selected region of an image. Image textures are one way that can be used to help in segmentation (image processing) or classification of images. In the embodiment, the storage system 20 saves the image textures of the images in the history record list according to a capture time of the images (i.e., a date and/or time of when the images have been captured by the image capturing device 10).

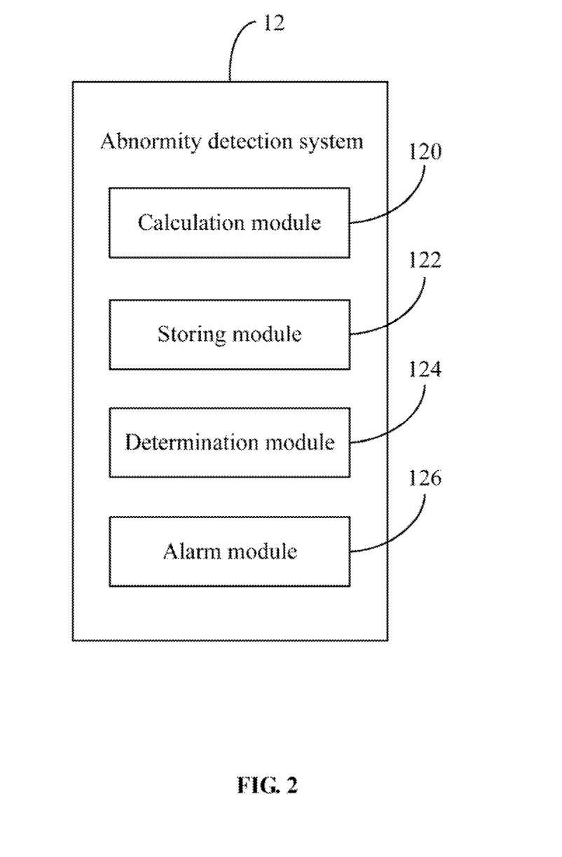

FIG. 2 is a block diagram of one embodiment of function modules of the abnormity detection system 12 of FIG. 1. In one embodiment, the abnormity detection system 12 includes a calculation module 120, a storing module 122, a determination module 124, and an alarm module 126. Each of the modules 120-126 may be a software program including one or more computerized instructions that are stored in the storage system 14 and executed by the processor 16.

The calculation module 120 captures an image (hereinafter “current image”) of a monitored area, and calculates an image texture of the current image. The image can be of a scene, such as a park, forest, etc. The image texture is a set of metrics that gives us information about a spatial arrangement of color or intensities in an image or selected region of an image.

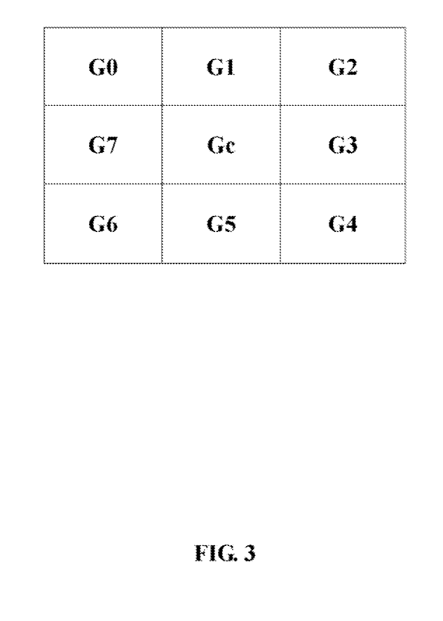

As shown in FIG. 3, the calculation module 120 calculates the image texture of a 3*3 gray image using following formulas:

$$Texture = {\sum }_{p = 0}^{7} s ( {G}_{p} - {G}_{c} ) \times {2}^{p} , \\ s ( x ) = \{ \begin{matrix}1 & if & x \geq 0 \\ 0 & if & x < 0 ,\end{matrix}$$

where p is equal to zero, one, two, three, four five, six, and seven. A range of the image texture of the 3*3 gray image is between 0 to 255. The calculation module 120 can calculate the image texture of each image captured at different times using the formula:

Histo[Texture]=Histo[Texture]+1.

The calculation module 120 determines whether a count of image textures recorded in the history record list is greater than a predetermined value. In one embodiment, the predetermined value may be three, four, five, six, seven, eight, or nine, for example, but is not limited to these numerical values as presented.

If the count of the image textures recorded in the history record list is not greater than the predetermined value, the storing module 122 saves the image texture of the current image in the history record list.

When the count of the image textures recorded in the history record list is greater than the predetermined value, the calculation module 120 further calculates texture difference values between the image texture of the current image and at least two image textures of the area recorded in the history record list.

For example, the calculation module 120 calculates a first texture difference value between the image texture of the current image and a first image texture recorded in the history record list, and calculates a second texture difference value between the image texture of the current image and a second image texture of the history record list. The first image texture and the second image texture are the image textures related to two images of the area captured by the image capturing device 10 at different times. In one embodiment, the first image texture related to an image that is captured near the current image, and the second image texture is related to an image that was captured at an earlier time.

In the embodiment, the calculation module 120 can calculate the texture difference values using following formulas:

$${D}_{s} = {\sum }_{i = 0}^{255} \vert H {isto}_{n} [ i ] - H {isto}_{s} [ i ] \vert , \\ {D}_{l} = {\sum }_{i = 0}^{255} \vert H {isto}_{n} [ i ] - H {isto}_{l} [ i ] \vert ,$$

where Ds is the texture difference value between the image texture of the current image and the first image texture related to an image that is captured near the current image, and D1 is the texture difference value between the image texture of the current image and the second image texture related to an image that was captured at an earlier time.

The determination module 124 compares all of the texture difference values with a threshold value. If all the texture difference values are greater than the threshold value, the determination module 124 determines that the current image is abnormal, and incrementing an abnormity record value of the image capturing device 10 by a value of one (namely W=W+1). If any one of the texture difference values is not greater than the threshold value, the determination module 124 further determines that the image is normal, and subtracts a value of one from the abnormity record value, namely W=W−1. In the embodiment, the threshold value can be preset based on a resolution of the current image.

In the embodiment, the abnormity record value W is a counter for recording the abnormities of the images captured by the image capturing device 10. W is indicated as a following formula:

$$w = \{ \begin{matrix}w + 1 & if & {D}_{s} , {D}_{l} \geq {T}_{d} \\ w - 1 & if & {D}_{s} , {D}_{l} < {T}_{d}\end{matrix}$$

When the abnormity record value W is equal to or greater than an alert value, the alarm module 126 generates an alarm to warn of an abnormity of the image capturing device 10. In the embodiment, the alert value is a value that represents how many abnormal images lead to the alarm module 126 alarm. In one embodiment, the alarm module 126 also can report a message to indicate that the image capturing device 10 is abnormal.

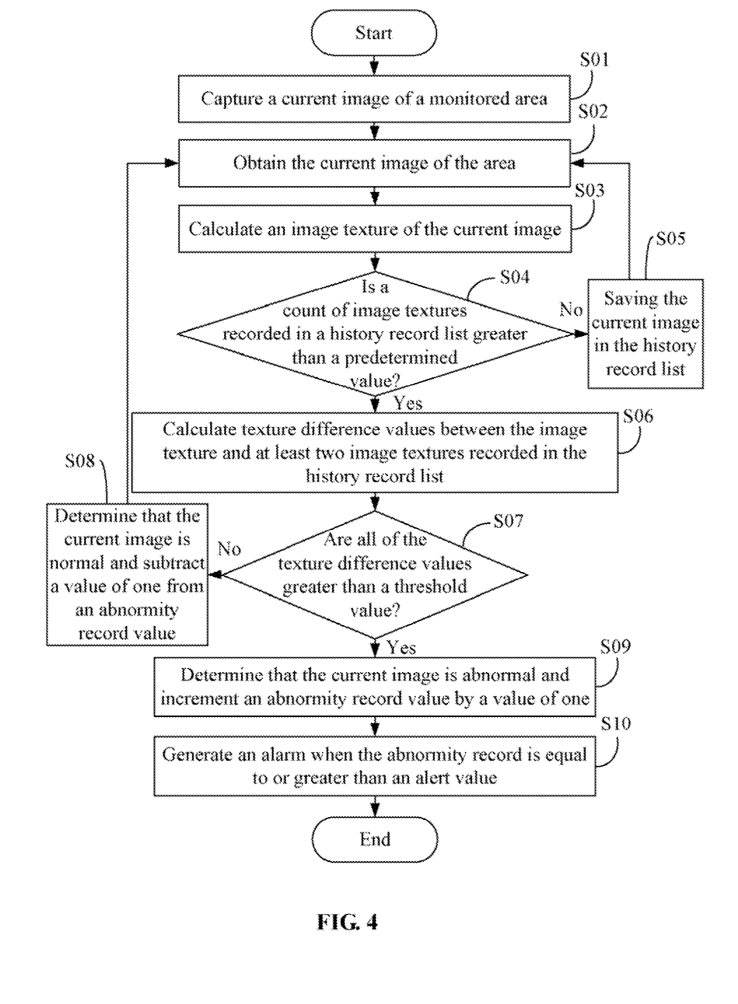

FIG. 4 is a flowchart illustrating one embodiment of a method for detecting an abnormity of an image capturing device using the abnormity detection system of FIG. 1. Depending on the embodiment, additional blocks may be added, others removed, and the ordering of the blocks may be changed.

In step S01, the image capturing device 10 is enabled to capture a monitored area.

In step S02, the calculation module 120 obtains the current image that has been captured by the image capturing device 10.

In step S03, the calculation module 120 calculates an image texture of the current image. In the embodiment, the image texture is a set of metrics that provides information about a spatial arrangement of color or intensities in an image or selected region of an image.

In step S04, the calculation module 120 determines whether a count of image textures recorded in the history record list is greater than a predetermined value, such as ten or twenty.

In response to the determination that the count is not greater than the predetermined value, in step S05, the storing module 122 saves the image texture of the current image in the history record list, and the flow returns to step S02.

In response to the determination that the count is greater than the predetermined value, in step S06, the calculation module 120 calculates texture difference values between the image texture of the current image and at least two image textures recorded in the history record list. For example, the calculation module 120 calculates a first texture difference value between the image texture of the current image and a first image texture recorded in the history record list, and calculates a second texture difference value between the image texture of the current image and a second image texture recorded in the history record list. In the embodiment, the first image texture and the second image textures are image textures related to two images captured by the image capturing device 10 at different times.

In step S07, the determination module 124 compares the first and second texture difference values with a threshold value, and determines whether all of the texture difference values are greater than the threshold value. If all of the texture difference values are greater than the threshold value, step S09 is implemented. If any one of the texture difference values is not greater than the threshold value, the flow goes to step S08.

In step S08, the determination module 124 determines that the current image is normal, and subtracts a value of one from the abnormity record value. That is, the abnormity record value W=W−1.

In step S09, the determination module 124 determines that the current image is abnormal, and increments the abnormity record value by a value of one. That is, the abnormity record value W=W+1.

Upon the condition that the abnormity record value W is equal to or greater than an alert value, in step S10, the alarm module 126 generates an alarm to warn of an abnormity of the image capturing device 10. In the embodiment, the alert value is a value that represents how many abnormal images lead to the alarm module 126 alarm.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method of an image capturing device, the method comprising:
capturing an image of a monitored area, and calculating an image texture of the image;
upon the condition that a count of image textures recorded in a history record list is greater than a predetermined value, calculating texture difference values between the image texture of the image and at least two image textures recorded in the history record list;
determining that the image is abnormal and incrementing an abnormity record value of the image capturing device by a value of one, upon the condition that all of the texture difference values are greater than a threshold value; and
generating an alarm upon the condition that the abnormity record value is equal to or greater than an alert value, the alert value being a value that represents how many abnormal images lead to the alarm generation.

2. The method as described in claim 1, further comprising:
saving the image texture of the image in the history record list, upon the condition that the count of the image textures recorded in the history record list is not greater than the predetermined value.

3. The method as described in claim 1, further comprising:
determining that the image is normal and subtracting a value of one from the abnormity record value, upon the condition that any one of the texture difference values is not greater than the threshold value; and
saving the image texture of the image in the history record list.

4. The method as described in claim 1, wherein the images related to the image textures are captured at different times.

5. An electronic device detecting an abnormity of an image capturing device, the electronic device comprising:
at least one processor;
a storage system; and
one or more modules that are stored in the storage system and executed by the at least one processor, the one or more modules comprising:
a calculation module that captures an image of a monitored area, and calculates an image texture of the image;
the calculation module further calculates texture difference values between the image texture of the image and at least two image textures of the area recorded in a history record list that is stored in the storage system, upon the condition that a count of image textures recorded in the history record list is greater than a predetermined value;
a determination module that determines that the image is abnormal and increments an abnormity record value of the image capturing device by a value of one, upon the condition that all of the texture difference values are greater than a threshold value; and
an alarm module that generates an alarm upon the condition that the abnormity record value is equal to or greater than an alert value, the alert value being a value that represents how many abnormal images lead to the alarm generation.

6. The electronic device as described in claim 5, further comprising:
a storing module that saves the image texture of the image in the history record list, upon the condition that the count of the image textures recorded in the history record list is not greater than the predetermined value or upon the condition that any one of the texture difference values is not greater than the threshold value.

7. The electronic device as described in claim 5, wherein the determination module further determines that the image is normal and subtracts a value of one from the abnormity record value, upon the condition that any one of the texture difference values is not greater than the threshold value.

8. The electronic device as described in claim 5, wherein the images related to the image textures are captured at different times.

9. A non-transitory storage medium having stored thereon instructions that, when executed by a processor of an electronic device, cause the electronic device to perform a method for detecting an abnormity of an image-capturing device, the method comprising:
capturing an image of a monitored area, and calculating an image texture of the image;
upon the condition that a count of image textures of the area recorded in a history record list is greater than a predetermined value, calculating texture difference values between the image texture of the image and at least two image textures recorded in the history record list;
determining that the image is abnormal and incrementing an abnormity record value of the image capturing device by a value of one, upon the condition that all of the texture difference values are greater than a threshold value; and
generating an alarm upon the condition that the abnormity record value is equal to or greater than an alert value, the alert value being a value that represents how many abnormal images lead to the alarm generation.

10. The storage medium as described in claim 9, wherein the method further comprises:
saving the image texture of the image in the history record list, upon the condition that the count of the image textures recorded in the history record list is not greater than the predetermined value.

11. The storage medium as described in claim 9, wherein the method further comprises:
determining that the image is normal and subtracting a value of one from the abnormity record value, upon the condition that any one of the texture difference values is not greater than the threshold value; and
saving the image texture of the image in the history record list.

12. The storage medium as described in claim 9, wherein the images related to the image textures are captured at different times.
